(19) United States
(12) Patent Application Publication
(10) Pub. No.: US 2021/0273520 A1
(43) Pub. Date: Sep. 2, 2021

(54) MOTOR

(71) Applicant: LG Electronics Inc., Seoul (KR)

(72) Inventors: Jongsu KIM, Seoul (KR); Taehee KWAK, Seoul (KR); Jungwook MOON, Seoul (KR); Changhum JO, Seoul (KR)

(21) Appl. No.: 17/259,409

(22) PCT Filed: Jun. 18, 2019
(86) PCT No.: PCT/KR2019/007314

§ 371 Date: Jan. 11, 2021

(30) Foreign Application Priority Data
Jul. 11, 2018 (KR) 10-2018-0080318

(51) Int. Cl. H02K 5/20; H02K 9/19

(52) U.S. Cl. CPC H02K 5/203; H02K 9/19

(57) ABSTRACT

The present invention relates to a motor having dual flow paths of an oil-water composite cooling method, the motor comprising: a motor housing accommodating a stator and a rotor therein; and the dual flow paths formed inside the motor housing so as to cool the stator and the rotor by means of the oil-water composite cooling method, wherein the dual flow paths comprise: an oil flow path formed in a spiral shape such that oil flows inside a wall body of the motor housing; and a cooling water flow path formed in a spiral shape such that cooling water flows inside the wall body of the motor housing, and can improve cooling efficiency and cooling performance.

### TECHNICAL FIELD

The present disclosure relates to an electric motor having dual passages for both water cooling and oil cooling systems.

### BACKGROUND

An electric car or vehicle (including hybrid vehicle) having an electric motor as a driving source has been released, which is considered as a future car as it has excellent fuel economy.

In general, an electric motor includes a rotor and a stator, and the rotor may be rotatably provided inside the stator.

The stator has a stator coil wound around the stator core. When a current is applied to the stator coil to rotate the rotor, heat is generated in the stator coil. As such, technologies for cooling the heat generated in the motor have been developed.

In a drive system including a motor of an electric vehicle and an inverter for driving the motor, cooling heat generated in the motor and the inverter plays an important role in size reduction and efficiency improvement of the drive system.

In the conventional motor cooling method or system, an indirect cooling system in which cooling water is circulated in a housing to indirectly cool down the motor, and a direct cooling system in which the motor is directly cooled by injecting or spraying oil onto a stator or a rotor are used.

The direct cooling system has better cooling efficiency and cooling performance than the indirect cooling system. Thus, research and development in the direct cooling system has been actively carried out in recent years.

An electric motor employing the conventional direct cooling system is disclosed in the following patent documents.

In Korean Laid-Open Patent Application No. KR10-2015-0051682 (hereinafter, “Patent Document 1”), which is hereby incorporated by reference, a motor cooling structure for directly cooling a stator, a rotor, and a shaft by pumping oil immersed in a bottom surface of a motor housing using an oil churning device is disclosed.

However, an oil injection device for directly injecting or spraying oil onto a stator coil that generates heat the most is not provided in Patent Document 1, so there is a limitation in increasing cooling performance of the motor, namely cooling a drive motor for a vehicle of 50 kW or more.

U.S. Patent Application No. US2004/0163409A1 (hereinafter, “Patent Document 2”, published on Aug. 26, 2004), which is hereby incorporated by reference, discloses a motor cooling structure that cools down a motor by individually (or separately) using an oil cooling type or a water cooling type.

In the case of the oil cooling type disclosed in Patent Document 2, an oil passage is configured to surround a stator coil so that oil absorbs heat generated in the stator coil, allowing a motor to be directly cooled.

As for the oil cooling type, a heat exchanger is provided at an outside of a motor housing, so as to cool oil that absorbs heat from the stator coil by heat exchange with cooling water.

In the case of the water cooling type, a cooling water passage is formed inside the motor housing, and cooling water flowing through the cooling water passage cools the motor housing so as to transfer heat generated in the stator coil to a stator core and the motor housing, thereby indirectly cooling the motor.

However, Patent Document 2 has the following problems.

First, the oil cooling type has good cooling efficiency and cooling performance. However, a heat exchanger should be provided at an outside of the housing in order to reduce a temperature of oil. This may increase costs, and not be suitable for reducing a size of the electric motor.

Second, as for the water cooling type, a heat exchanger is not required, but cooling efficiency and cooling performance are not good.

### SUMMARY

The present disclosure describes a (electric) motor having dual cooling passages capable of simultaneously applying oil cooling and water cooling systems, thereby improving cooling efficiency and cooling performance, as well as reducing costs and a size of the motor as there is no need to provide a heat exchanger to an outside of a motor housing.

The present disclosure also describes a motor capable of increasing cooling efficiency and cooling performance by providing an injection port through which oil is sprayed directly onto a stator.

According to one aspect of the subject matter described in this application, a motor having dual passages for oil and water cooling systems includes a motor housing in which a stator and a rotor are accommodated therein, and dual passages formed inside the motor housing and configured to cool the stator and the rotor using a combination of oil cooling and water cooling. The dual passages may include an oil passage formed in a spiral shape so as to allow oil to flow in a wall of the motor housing, and a cooling water passage formed in a spiral shape so as to allow cooling water to flow in the wall of the motor housing.

Implementations according to this aspect may include one or more of the following features. For example, the stator may be provided with a stator core and a stator coil wound around the stator core, and the dual passages may further include a plurality of oil injection ports each having one side communicating with the oil passage and another side communicating with an inner space of the motor housing, so as to directly spray oil onto an end coil of the stator coil axially protruding from the stator core, or the rotor.

In some implementations, the dual passages may further include an oil outlet port formed at a bottom surface inside the motor housing.

In some implementations, the dual passages may further include an axial passage part axially extending at an upper end inside the wall of the motor housing, having one side being connected to communicate with the oil passage, and provided with the plurality of oil injection ports formed at a front end and a rear end thereof, respectively.

In some implementations, the oil passage may be disposed at an outer side in the wall of the motor housing, and the cooling water passage may be disposed at an inner side in the wall of the motor housing.

In some implementations, the oil passage and the cooling passage may overlap each other along a radial direction of the motor housing.

In some implementations, the oil passage may include a plurality of first passage portions configured as a plurality of columns so as to be disposed to be spaced apart from one another along a lengthwise direction of the motor housing and extending along a circumferential direction of the motor housing, and a plurality of second passage portions extending in an inclined manner along the lengthwise direction of the motor housing, so as to connect the plurality of first passage portions disposed adjacent to each other along the lengthwise direction of the motor housing.

In some implementations, the cooling water passage may include a plurality of first passage portions configured as a plurality of columns so as to be disposed to be spaced apart from one another along a lengthwise direction of the motor housing and extending along a circumferential direction of the motor housing, and a plurality of second passage portions extending in an inclined manner along the lengthwise direction of the motor housing so as to connect the plurality of first passage portions located adjacent to one another along the lengthwise direction of the motor housing.

In some implementations, an oil pump integrally mounted to one side surface of the motor housing in a manner of communicating with the oil passage may be further provided, so that oil discharged from a bottom surface of the motor housing is circulated to an upper end of the motor housing.

In some implementations, a cooling water inlet port disposed at an upper portion of the motor housing may be further provided to communicate with one side of the cooling water passage, and a cooling water outlet port disposed at a lower portion of the motor housing may be further provided to communicate with another side of the cooling water passage.

In some implementations, the motor housing may include an outer housing provided therein with the oil passage, and an inner housing press-fitted to an inner side of the outer housing and provided therein with the cooling water passage.

The embodiments of the present disclosure may provide at least one or more of the following benefits.

First, cooling performance and a motor output may be increased by providing a plurality of injection ports for spraying oil directly onto a stator coil from an upper part of a motor housing to directly cool the motor.

Second, as a spiral type first cooling passage is provided at an outside of the motor housing to allow oil to flow therein, and a spiral type second cooling passage is provided inside the housing to allow cooling water to flow therein so as to enable heat exchange with the first cooling passage, oil may be cooled by cooling water while flowing along the first cooling passage until it is introduced into the injection ports at the upper part of the housing. Thus, a heat exchange system for heat exchange with oil is not required at the outside the motor housing, enabling cost savings and a compact structure of the motor.

Third, as the spiral type dual cooling passages are provided inside the motor housing, a contact area for heat exchange between the oil passage and the cooling water passage is increased, thereby increasing heat dissipation performance of the motor, and achieving a size reduction while maintaining the same motor output.

Fourth, as the spiral type dual passages for both oil and water cooling systems (or oil-water composite cooling method) in which heat exchange is performed simultaneously, hybrid driving (or operation) may be available according to an amount of motor heating, thereby increasing cooling efficiency than the conventional oil cooling system in which an oil pump is operated at all times.

Fifth, as cooling water is only circulated under low heat conditions in which an external temperature is low, a reliability problem due to an increase in oil viscosity at a low temperature may be solved.

Sixth, a higher output may be available as the dual passages for the oil and water cooling systems provide better heat dissipation performance, which is suitable for being used to cool a motor for driving a vehicle of 50 kW or more.

Seventh, as the dual passages for the oil and water cooling systems, a temperature of the motor housing is kept low by cooling water, thereby increasing a lifespan of a bearing.

Eighth, as an oil pump and the motor housing are integrally coupled, a size reduction of the motor may be achieved to thereby increase design freedom in mounting the motor to a vehicle.

Ninth, as the oil passage and the cooling water passage are formed in a spiral manner, flow resistance of a cooling fluid may be minimized.

### BRIEF DESCRIPTION OF THE DRAWINGS

FIG. 1 is a perspective view of a motor according to the present disclosure.

FIG. 2 is a perspective view of the motor of FIG. 1, viewed from the rear.

FIG. 3 is a front view of the motor in FIG. 1, viewed from the front along an axial direction.

FIG. 4 is a cross-sectional view taken along line “IV-IV” of FIG. 3.

FIG. 5 is a perspective view illustrating dual cooling passages formed in a motor housing of FIG. 3.

FIG. 6 is a perspective view illustrating the dual cooling passages of FIG. 5, viewed from the rear along an axial direction.

FIG. 7 is a lateral view of the dual cooling passages of FIG. 3, viewed from one side surface thereof.

FIG. 8 is a bottom perspective view illustrating a flow path of oil in FIG. 5.

FIG. 9 is a perspective view of a cooling water passage with an oil passage in FIG. 5 removed.

FIG. 10 is a perspective view illustrating the cooling water passage of FIG. 9, viewed from the rear along an axial direction.

FIG. 11 is a lateral view illustrating the cooling water passage of FIG. 9, viewed from one side surface thereof.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the main point of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, it will be understood that when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

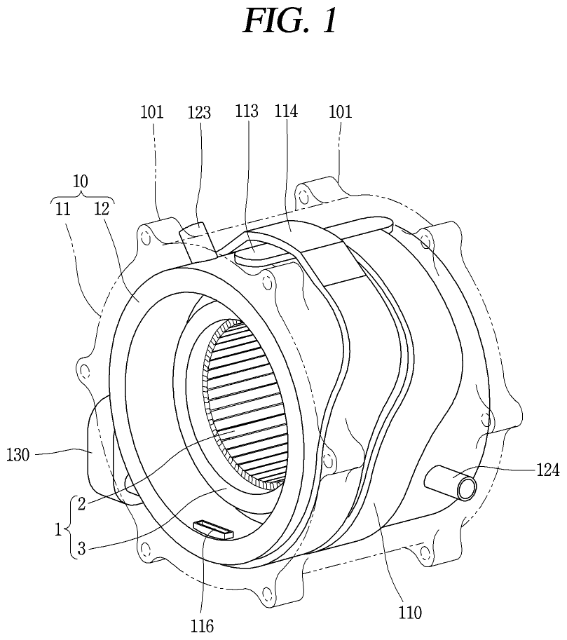

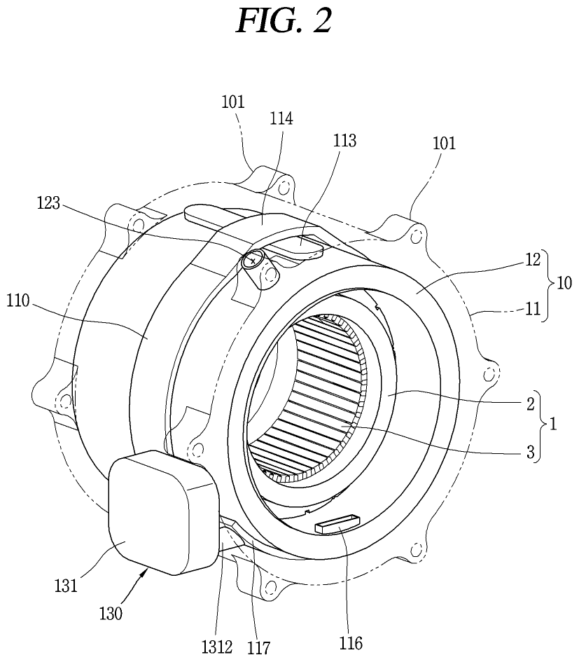

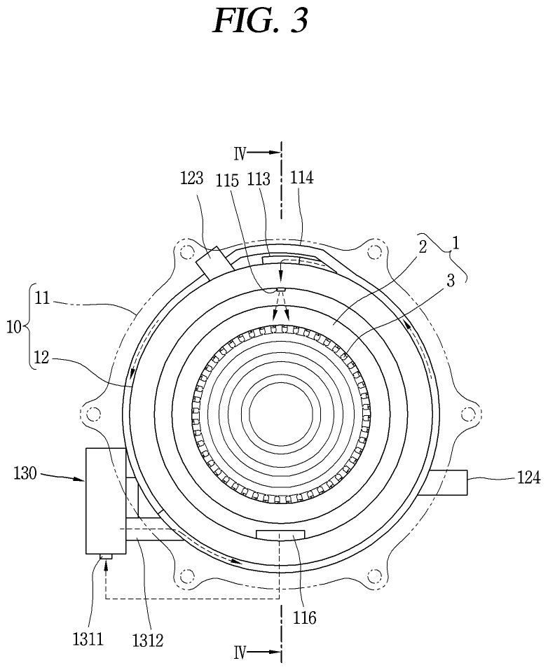

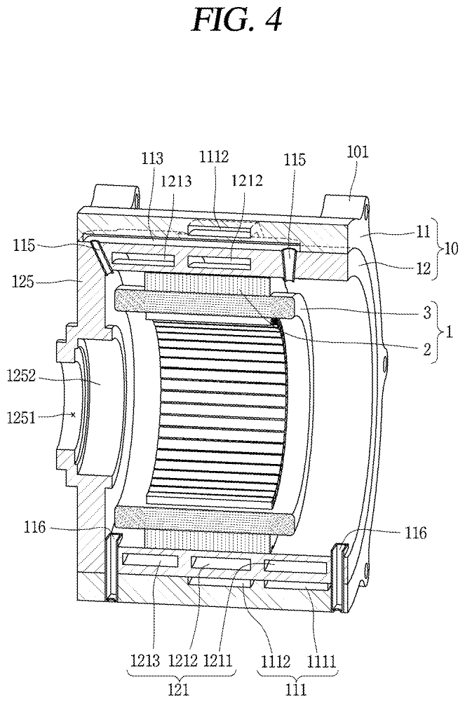

FIG. 1 is a perspective view of a motor according to the present disclosure, FIG. 2 is a perspective view of the motor of FIG. 1, viewed from the rear, FIG. 3 is a front view of the motor in FIG. 1, viewed from the front along an axial direction, and FIG. 4 is a cross-sectional view taken along line “IV-IV” of FIG. 3.

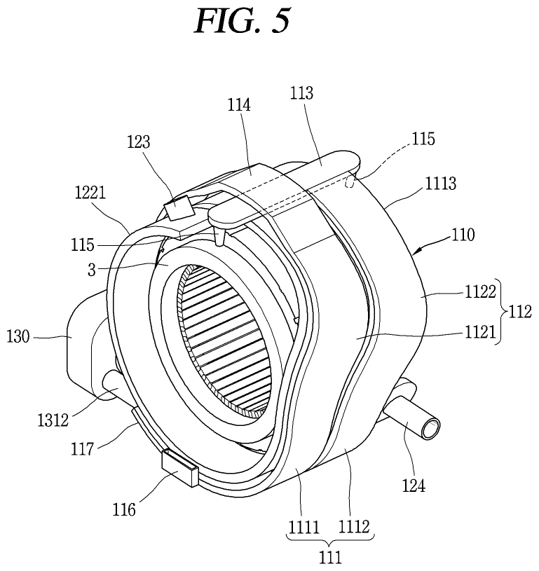

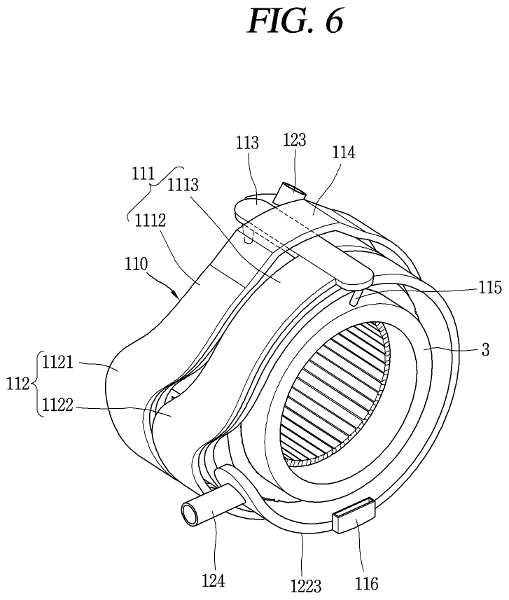

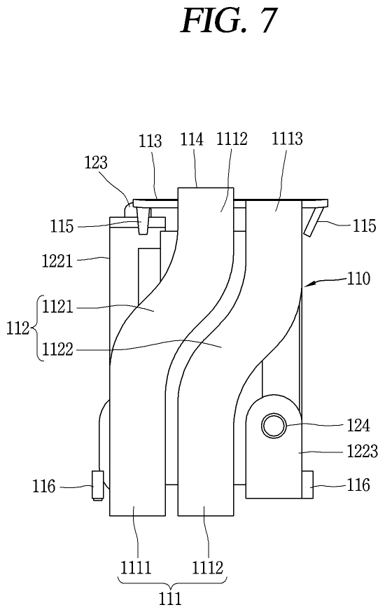

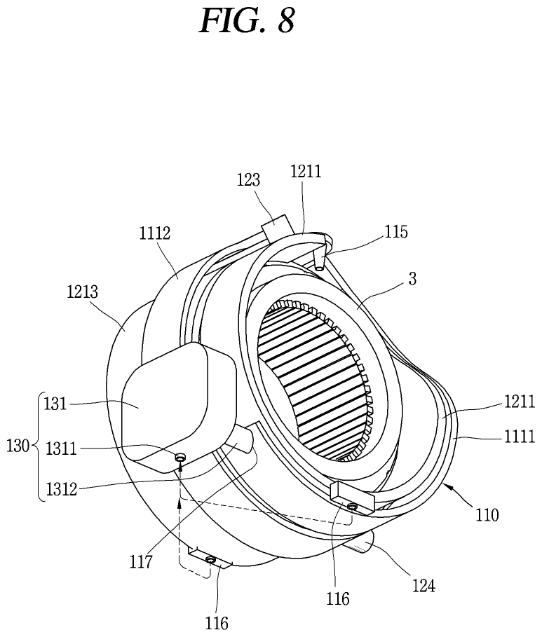

FIG. 5 is a perspective view illustrating dual cooling passages formed in a motor housing of FIG. 3, FIG. 6 is a perspective view illustrating the dual cooling passages of FIG. 5, viewed from the rear along an axial direction, FIG. 7 is a lateral view of the dual cooling passages of FIG. 3, viewed from one side surface thereof, and FIG. 8 is a bottom perspective view illustrating a flow path of oil in FIG. 5.

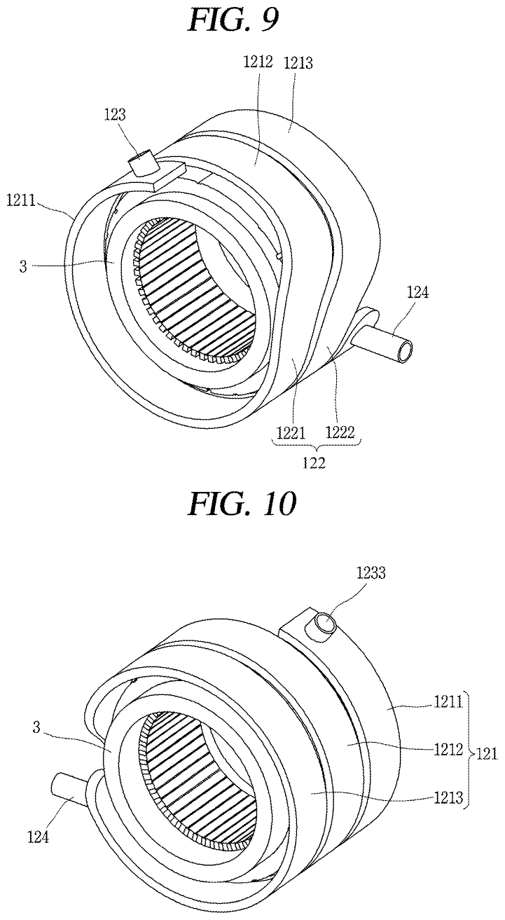

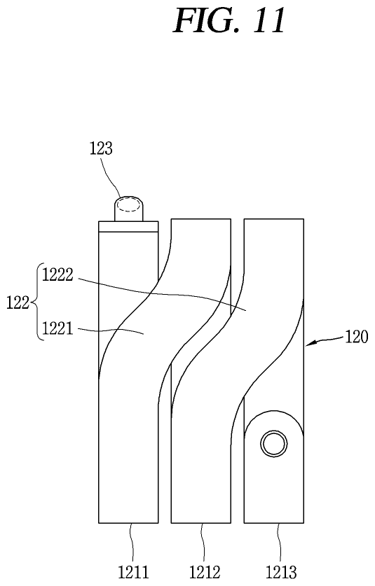

FIG. 9 is a perspective view of a cooling water passage with an oil passage in FIG. 5 removed, FIG. 10 is a perspective view illustrating the cooling water passage of FIG. 9, viewed from the rear along an axial direction, and FIG. 11 is a lateral view illustrating the cooling water passage of FIG. 9, viewed from one side surface thereof.

A motor (electric motor) according to the present disclosure may be applied to an electric vehicle or a hybrid vehicle. The motor may provide a driving force that allows driving wheels of the vehicle to be driven.

The motor includes a motor housing 10. A stator 1 and a rotor may be provided inside the motor housing 10. The stator 1 includes a stator core 2 and a stator coil 3 wound around the stator core 2.

The rotor is provided inside the stator core 2 to be rotatably installed with respect to the stator 1. As a rotating (or rotational) shaft is provided inside the rotor, the rotor may be rotatably provided together with the rotating shaft.

The motor housing 10 may be formed in a cylindrical shape so as to allow the stator 1 and the rotor to be accommodated therein. Both sides of the motor housing 10 may be open along an axial direction. The motor housing 10 may be provided with a plurality of coupling portions 101 formed at a front end and a rear end thereof.

A rear cover is coupled to the rear end of the motor housing 10 to cover a rear part (or side) of the motor housing 10. The rear cover may be formed in a plate shape to cover the rear part of the motor housing 10, and the motor housing 10 may be provided with the plurality of coupling portions 101 through which the rear cover is coupled to the motor housing 10.

An inverter may be integrally coupled to a front end of the motor to control driving of the motor.

The inverter includes a cylindrical-shaped inverter housing in which electronic components for driving the motor is accommodated. The inverter housing may be coupled to the front end of the motor housing 10.

The motor housing 10 may be provided with dual cooling passages (or paths). The dual cooling passages may be configured to allow different fluids to flow therethrough. One of the dual cooling passages may be configured to allow oil to flow therethrough. The remaining one of the dual cooling passages may be configured to allow cooling water to flow therethrough.

An oil passage (or oil flow path) 110 and a cooling water passage (or cooling water flow path) 120 may be disposed to overlap each other in a radial direction of the motor housing 10.

The oil passage 110 may be disposed at an outer side in a wall (or wall structure) of the motor housing 10, and the cooling water passage 120 may be disposed at an inner side in the wall structure of the motor housing 10.

The motor housing 10 may include an outer housing 11 and an inner housing 12.

Each of the outer housing 11 and the inner housing 12 may be formed in a cylindrical shape having a hollow portion formed therein.

The outer housing 11 may be provided with the oil passage 110 through which oil flows.

The inner housing 12 may include the cooling water passage 120 through which cooling water flows.

The rear cover may radially extend from a rear part of the inner housing 12. A rotating shaft hole through which the rotating shaft penetrates may be formed at the rear cover. A bearing accommodation (or receiving) portion in which a bearing is accommodated is provided at the rear cover, and the bearing may be mounted to the bearing accommodation portion.

The oil passage 110 and the cooling water passage 120 may extend along a spiral (or helix) direction, respectively.

Each of the oil passage 110 and the cooling water passage 120 may be formed in a spiral type (or manner).

Each of the oil passage 110 and the cooling water passage 120 may include a first passage part (111, 121) having a plurality of passage portions (or sections) extending in a circumferential direction, and a second passage part (112, 122) having a plurality of passage portions connecting the plurality of passage portions of the first passage part (111, 121).

The first passage part (111, 121) and the second passage part (111, 122) may define one oil passage 110, or one cooling water passage 120.

The first passage part 111 may be formed in an arcuate or circular shape and extend along the circumferential direction without extending in the axial direction. Both ends of the first passage part 111 may radially overlap each other.

The second passage part 112 may be formed in an arcuate or circular shape and extend along the circumferential direction as well as the axial direction, so as to connect two adjacent passage portions disposed in different columns of the first passage part 111 along the axial direction.

The plurality of passage portions of the first passage part 111 and the plurality of passage portions of the second passage part 112 may be disposed to be spaced apart from one another along the axial direction.

For example, the oil passage 110 may extend starting from the lowermost end of the motor housing 10 to the uppermost end of the motor housing 10 spanning approximately one and a half turns (540 degrees) of the motor housing 10.

The first passage part 111 of the oil passage 110 may extend while rotatably moving in a counterclockwise direction. The plurality of passage portions of the first passage part 111 may be configured as first to Nth columns from the front to the rear along the axial direction. In this embodiment, the first passage part 111 may be configured as three columns.

The second passage part 112 may be located to be inclined to a right side along the counterclockwise direction, so as to connect the passage potions of the first passage part 111 that are disposed in different columns. In this embodiment, the second passage part 112 may be configured as two columns from the front to the rear along the axial direction.

An axial passage part 113 may be provided at the top of an inside of the wall of the motor housing 10.

The axial passage part 113 may extend along an axial direction of the motor housing 10. The axial passage part 113 may extend in a direction crossing the plurality of portions of the first passage part 111.

The axial passage part 113 and the oil passage 110 may extend at an upper end of the motor housing 10 in a direction crossing each other. The axial passage part 113 may extend along a lengthwise direction of the motor housing 10, and the oil passage 110 may extend along the circumferential direction.

A crossing portion 114 may be formed at an upper end of a passage portion 1112 located in a second column of the first passage part 111. The crossing portion 114 may be provided at the top of the oil passage 110 to be located higher than passage portions 1111 and 1113 disposed in other columns of the first passage part 111 in order to avoid flow path interference with the axial passage part 113. The crossing portion 114 may extend to cross an upper part of the axial passage 113 along the circumferential direction.

Here, the axial passage part 113 and the crossing portion 114 may partially overlap each other in the radial direction and be spaced apart from each other in the radial direction, so that the oil passage 110 in a spiral direction and the axial passage part 113 do not overlap with each other, oil may bypass the axial passage part 113 to flow along the circumferential direction.

A plurality of oil injection ports 115 may be provided at the axial oil passage part 113. The plurality of oil injection ports 115 may be respectively disposed at front and rear ends of the axial passage part 113. The plurality of oil injection ports 115 may be located toward end coils of the stator 1.

The plurality of oil injection ports 115 may radially penetrate from the uppermost end of the motor housing 10. Oil may be sprayed through the plurality of oil injection ports 115 onto the end coils protruding outward from front and rear ends of the stator core 2 along its lengthwise direction.

The plurality of oil injection ports 115 may extend radially inward from the axial oil passage part 113. Of the plurality of oil injection ports 115, a first oil injection port 115 disposed at the front end of the axial oil passage part 113 in its lengthwise direction may extend vertically downward, and a second oil injection port 115 disposed at the rear end thereof may be inclined downward to the end coils.

The plurality of oil injection ports 115 may be formed in a conical (cone) shape having a cross-sectional area that gradually becomes smaller or narrower from the top to the bottom, allowing an oil injection speed to be increased.

Referring to FIG. 7, the passage portion 1111 of a first column of the first passage part 111 may upwardly extend from the lowermost end of the motor housing 10 to a middle portion thereof along the counterclockwise direction, so as to be connected to a lower end of a passage portion 1121 of a first column of the second passage part 112. The passage portion 1121 of the first column may extend along the axial direction to change the column so as to be connected to the passage portion 1112 of the second column of the first passage part 111 from the passage portion 1111 of the first column of the first passage part 111.

Then, the passage portion 1112 of the second column of the first passage part 111 may extend starting from an upper portion of the motor housing 10, the lowermost end thereof, to the middle portion thereof along the counterclockwise direction, so as to be connected to a lower end of a passage portion 1122 of a second column of the second passage part 112. The passage portion 1122 of the second column of the second passage part 112 may extend along the axial direction to change the column so as to be connected to a passage portion 1113 of a third column of the first passage part 111.

Subsequently, the passage portion 1113 of the third column of the first passage part 111 may extend in the counterclockwise direction, so as to be connected to the rear end of the axial passage part 113 located at the uppermost end of the motor housing 10.

A plurality of oil outlet ports 116 may be formed at the lowermost end of the motor housing 10. The plurality of oil outlet ports 116 may be disposed at the front and rear ends of the motor housing 10, respectively. The plurality of oil outlet ports 116 may extend in the radial direction.

The oil outlet port 116 may be formed such that its upper end is in communication with an inner space of the motor housing 10 and its lower end is in communication with an outside of the motor housing 10. A communication hole may extend from the lowermost end of the oil outlet port 116 in a tangential direction, so as to communicate with the outside of the motor housing 10.

Oil may circulate through the oil passage 110 formed inside the motor housing 10 by circulation power generated by an oil pump 130.

The oil pump 130 may be mounted on a lower left surface of the motor housing 10 when the motor housing 10 is viewed from the front in the axial direction.

The oil pump 130 may include a pump housing 131, a pump impeller, and a pump drive unit.

A pump inlet port 1311 may be formed ata bottom surface of the pump housing 131, and the pump inlet port 1311 may be connected to communicate with the oil outlet port 116.

A pump outlet port 1312 may be provided at an inner surface of the pump housing 131, and the pump outlet port 1312 may be connected to communicate with an oil inlet port 117 formed inside the motor housing 10. The oil inlet port 117 may be provided at the lowermost end of the motor housing 10. The oil inlet port 117, which is a starting point of the oil passage 110, may be connected to the lowermost end of the passage portion 1111 of the first column of the first passage part 111.

The pump impeller may be rotatably installed inside the pump housing 131 so that oil introduced through the pump inlet port 1311 is pumped to be discharged to the oil inlet port 117 of the motor housing 10 through the pump outlet port 1312.

The pump drive unit may be implemented as a motor that drives the pump impeller.

The cooling water passage 120 may be formed at the inner side in the wall of the motor housing 10.

The cooling water passage 120 may be formed in a spiral type (manner).

The cooling water passage 120 may include a cooling water inlet port 123, the first passage part 121 having the plurality of passage portions, the second passage part 122 having the plurality of passage portions, and a cooling water outlet port 124.

The cooling water inlet port 123 may be disposed at one side of the upper portion of the motor housing 10 along the circumferential direction. One side of the cooling water inlet port 123 may communicate with one side of the cooling water passage 120, and another side of the cooling water inlet port 123 may be connected to the outside of the motor housing 10.

The cooling water outlet port 124 may be disposed at one side of a lower portion of the motor housing 10 along the circumferential direction. One side of the cooling water outlet port 124 may communicate with another side of the cooling water passage 120, and another side of the cooling water outlet port 124 may be connected to the outside of the motor housing 10.

The cooling water inlet port 123 and the cooling water outlet port 124 may be connected to a cooling water circulation system.

The cooling water circulation system may be configured to cool cooling water. The cooling water circulation system includes a radiator disposed at the front of the vehicle, a first circulation passage that connects the cooling water inlet port 123 and the radiator, a second circulation passage that connects the cooling water outlet port 124 and the radiator, and a water pump that provides circulation power to circulate the cooling water.

Cooling water discharged from the cooling water outlet port 124 may flow along the first circulation passage to be cooled by heat exchange with external air in the radiator, and then move along the second circulation passage to flow into the cooling water passage 120 again through the cooling water inlet port 123.

The first passage part 121 having the plurality of passage portions may extend along the circumferential direction. The plurality of passage portions of the first passage part 121 may be spaced apart from one another along a lengthwise direction, and the first passage part 121 may be configured as first to Mth columns. In this embodiment, the first passage part 121 of the cooling water passage 120 may be configured to have three columns.

The plurality of passage portions of the second passage part 122 may extend from a partial section along the circumferential direction and extend obliquely from the front to the rear along the lengthwise direction. The plurality of passage portions of the second passage part 122 may be configured to connect the plurality of passage portions of the first passage part 121.

The plurality of passage portions of the second passage part 122 may be spaced apart from each other in the lengthwise direction, and the second passage part 122 may be configured as first to Lth columns. In this embodiment, the second passage part 122 of the cooling water passage 120 may be configured as two columns.

One side of a passage portion 1211 of a first column of the first passage part 121, which is located at the front of the motor housing 10 in its lengthwise direction, may be connected to the cooling water inlet port 123 and another side thereof may extend from the upper portion of the motor housing 10 in the counterclockwise direction so as to be connected to a lower end of a passage portion 1221 of a first column of the second passage part 122.

Then, one side of a passage portion 1212 of a second column, which is located at the middle of the motor housing 10 in its lengthwise direction, may be connected to an upper end of the passage portion 1221 of the first column and another side thereof may be connected to a lower end of a passage portion 1222 of a second column of the second passage part 122.

Subsequently, one side of a passage portion 1213 of a third column of the first passage part 121, which is located at the rear of the motor housing 10 in its lengthwise direction, may be connected to an upper end of the passage portion 1222 of the second column and another side thereof may extend from the upper portion of the motor housing 10 in the counterclockwise direction so as to be connected to the cooling water outlet port 124.

According to the present disclosure, the cooling water passage 120 and the oil passage 110 define dual passages inside the wall (thickness) of the motor housing 10, so as to allow cooling water and oil to flow respectively. Oil may flow along the oil passage 110 in the spiral direction, and heat generated from the stator coil 3 may be dissipated with oil by spraying oil directly onto the end coils of the stator 1, or the rotor through the oil injection port 115.

The oil absorbing heat from the stator coil 3 may be introduced again into the oil passage 110 in the motor housing 10 and flow along the oil passage 110 to be cooled by heat exchange with cooling water.

The cooling water may be introduced into the motor housing 10 from the cooling water circulation system through the cooling water inlet port 123 and flow in the helical direction along the cooling water passage 120. Heat generated in the stator core 2 may be dissipated with the cooling water.

The cooling water may be discharged to the outside of the motor housing 10 through the cooling water outlet port 124, and heat may be dissipated with air from the radiator while flowing along the cooling water circulation system.

With this configuration, the dual passages for both oil and water cooling systems may increase cooling performance by directly cooling the stator coil 3 using the plurality of oil injection ports 115.

As the dual passages for both the oil and water cooling systems are formed in a spiral shape, a pressure loss may be reduced than a cooling water passage extending in the axial direction.

In addition, as the dual passages for both the oil and water cooling systems are formed in the spiral shape, heat dissipation performance may be enhanced by expanding a heat exchange area between oil and cooling water inside the motor housing 10.

Further, as oil introduced through the oil inlet port 117 is cooled by cooling water until it flows into the oil injection port 115, a heat exchanger for cooling the oil is not required separately, which may greatly contribute to size and weight reduction of the motor.

As the oil pump 130 is integrally mounted to one side surface of the motor housing 10, the size of the motor is reduced to thereby increase design freedom, in terms of layout of the vehicle drive unit.

1. A motor, comprising:
a motor housing;
a stator and a rotor that are accommodated in the motor housing; and
dual passages defined inside the motor housing and configured to guide oil and water to cool the stator and the rotor,
wherein the dual passages comprise:
an oil passage that has a spiral shape and is configured to guide oil through a wall of the motor housing, and
a cooling water passage that has a spiral shape and is configured to guide water through the wall of the motor housing.

2. The motor of claim 1, wherein the stator comprises a stator core and a stator coil that is wound around the stator core, the stator coil comprising an end coil that axially protrudes relative to the stator core, and
wherein the dual passages further comprise a plurality of oil injection ports that communicate with the oil passage and an inner space of the motor housing and that are configured to directly spray oil to the end coil or the rotor.

3. The motor of claim 2, wherein the dual passages further comprise an oil outlet port defined at an inside surface of the motor housing.

4. The motor of claim 2, wherein the dual passages further comprise an axial passage part that axially extends from an upper end of the motor housing and is disposed radially inward relative to the wall of the motor housing, the axial passage part comprising a side surface that is connected to the oil passage, and end portions that define the plurality of oil injection ports.

5. The motor of claim 1, wherein the oil passage is defined at an outer side relative to the cooling water passage within the wall of the motor housing.

6. The motor of claim 1, wherein the oil passage and the cooling water passage overlap each other along a radial direction of the motor housing.

7. The motor of claim 1, wherein the oil passage comprises:
a plurality of first passage portions that are spaced apart from one another in a lengthwise direction of the motor housing and extend along a circumferential direction of the motor housing; and
a plurality of second passage portions that extend in a direction inclined with respect to the lengthwise direction of and to connect two of the plurality of first passage portions disposed adjacent to each other along the lengthwise direction.

8. The motor of claim 1, wherein the cooling water passage comprises:
a plurality of first passage portions that are spaced apart from one another in a lengthwise direction of the motor housing and extend along a circumferential direction of the motor housing; and
a plurality of second passage portions that extend in a direction inclined with respect to the lengthwise direction and connect two of the plurality of first passage portions located adjacent to each other along the lengthwise direction.

9. The motor of claim 1, further comprising an oil pump disposed at an outer surface of the motor housing and configured to communicate with the oil passage, the oil pump configured to circulate oil discharged from a bottom surface of the motor housing to an upper end of the motor housing.

10. The motor of claim 1, further comprising:
a cooling water inlet port defined at a first portion of the motor housing and configured to communicate with one side of the cooling water passage; and
a cooling water outlet port defined at a second portion of the motor housing and configured to communicate with another side of the cooling water passage.

11. The motor of claim 1, wherein the motor housing comprises:
an outer housing that defines the oil passage; and
an inner housing that is press-fitted to an inner side of the outer housing and defines the cooling water passage.

12. An electric motor, comprising:
a motor housing comprising an outer housing and an inner housing;
a stator and a rotor that are accommodated in the inner housing; and
dual passages defined inside the motor housing and configured to guide oil and water to cool the stator and the rotor,
wherein the dual passages comprise:
an oil passage that has a spiral shape and is configured to guide oil through a wall of the outer housing, and
a cooling water passage has a spiral shape and configured to guide water through a wall of the inner housing.

13. The electric motor of claim 12, wherein the oil passage comprises:
a plurality of first passage portions that extend along a circumferential direction of the outer housing and define a plurality of columns that are spaced apart from one another in a lengthwise direction of the outer housing; and
a plurality of second passage portions that extend in a direction inclined with respect to the lengthwise direction and connect two of the plurality of first passage portions corresponding to different columns among the plurality of columns.

14. The electric motor of claim 13, wherein the plurality of second passage portions overlap one another along the lengthwise direction of the outer housing.

15. The electric motor of claim 13, wherein the oil passage further comprises:
an axial passage part that is disposed at an upper end of the outer housing and extends in the lengthwise direction of the outer housing; and
a plurality of oil injection ports that are defined at ends of the axial passage part and extend from the axial passage part to the inner housing in a thickness direction of the motor housing.

16. The electric motor of claim 15, wherein a diameter of each of the plurality of oil injection ports gradually decreases from the axial passage part to an inside of the inner housing.

17. The electric motor of claim 15, wherein a part of the oil passage extends in a direction crossing the axial passage part and passes between the axial passage part and the wall of the outer housing.

18. The electric motor of claim 12, further comprising:
an oil outlet port that is defined at an inner surface of the inner housing and penetrates the inner housing and the outer housing in a thickness direction of the motor housing;
an oil inlet port defined at the oil passage and positioned below a center line that horizontally passes a center of the outer housing, the oil inlet port being in communication with the oil passage; and
an oil pump configured to transfer oil from the oil outlet port to the oil inlet port and to circulate the oil along the oil passage from the oil inlet port to an upper portion of the outer housing above the center line.

19. The electric motor of claim 12, wherein the cooling water passage comprises:
a plurality of first passage portions that extend along a circumferential direction of the inner housing and define a plurality of columns spaced apart from one another in a lengthwise direction of the inner housing; and
a plurality of second passage portions that extend in a direction inclined with respect to the lengthwise direction and connect two of the plurality of first passage portions corresponding to different columns among the plurality of columns.

20. The electric motor of claim 12, further comprising:
a cooling water inlet port that is defined at a first portion of the cooling water passage and penetrates the outer housing and the inner housing in a thickness direction of the motor housing, the cooling water inlet port being configured to supply water into the cooling water passage; and
a cooling water outlet port that is defined at a second position of the cooling water passage and penetrates the inner housing and the outer housing in the thickness direction, the cooling water outlet port being configured to discharge water from the cooling water passage.
